(19) United States
(12) Patent Application Publication
(10) Pub. No.: US 2011/0177827 A1
(43) Pub. Date: Jul. 21, 2011

(54) Pilot Beacon System

(75) Inventors: William Jordan Crilly, JR., Dunbarton, NH (US); David Jay Schwartz, Tualatin, OR (US)

(73) Assignee: CELLULAR SPECIALTIES, INC., Manchester, NH (US)

(21) Appl. No.: 13/009,803

(22) Filed: Jan. 19, 2011

Related U.S. Application Data
(60) Provisional application No. 61/336,238, filed on Jan. 19, 2010.

(51) Int. Cl. H04W 64/00; H04B 17/00

(52) U.S. Cl. 455/456.1; 455/67.11

(57) ABSTRACT

A system of and method of accurate positioning of a wireless handset combines a positioning signal with the communication signal. For locations where a wireless handset cannot receive an adequate signal, the system receives a carrier signal either through a donor antenna, exterior the building, or a base station connected to the carrier. In addition to a communication signal, the system adds a location signal to assist the wireless handset in determining the wireless handset's location. The power level of the location signal, a pilot beacon signal, is adjusted so to be sufficiently strong but not at a level that will cause interference with the communication signal. The pilot beacon signal uses a different path than the communication signal to minimize delays. In addition, the system adjusts the offset, either positively or negatively, to account for timing delays caused by hardware and cables. The pilot beacon signal has multiple channels so that each repeating antenna has a distinct pilot beacon signal. Each handset always hears a pilot beacon signal, regardless of what channel the handset picks to communicate on.

### CROSS-REFERENCE TO RELATED APPLICATIONS

The present application claims the benefit of Provisional Patent Application No. 61/336,238 filed Jan. 19, 2010, which is incorporated herein by reference.

### FIELD OF THE INVENTION

This invention relates generally to facilitating locating the position of a cellular handset and more particularly to a pilot beacon system with a cellular wireless telephone system to facilitate the accurate positioning or location determination of the handset.

### BACKGROUND OF THE INVENTION

It has become common when using a cellular handset or smart-phone to have the capability to accurately locate the position of the cellular device. Positioning is required during a 911 emergency call, and for the use of location-aware software applications (LASA), e.g. navigation and location-targeted advertising. Cellular location technologies use one or more of a variety of methods, including Uplink-Time Difference of Arrival (U-TDOA) for GSM networks, Advanced Forward Link Trilateration (AFLT) for CDMA networks, and handset-based Global Positioning System (GPS) or Assisted GPS (A-GPS) in any type of cellular network to determine the location of the handset.

The number of indoor repeater applications has increased greatly in the last several years (and should continue to expand unabated). Today's public safety sensitive environment has highlighted a shortcoming of these designs. Although the increased indoor wireless coverage has proved to be a boon for the wireless customer from both a value of service and safety standpoint, recent gains in location services for both navigation and public safety have left indoor applications as position location holes.

In indoor applications, the normal methods used for location determination, direct reception of GPS by the mobile station or triangulation using the signals from multiple base stations, do not work. Signals from the GPS system are sufficiently weak that even if the mobile station's GPS receiver might ultimately be able to lock on to the satellites, the acquisition time will be too long. Furthermore, indoor service is typically provided either by a single strong local cell, distributed within the building, or by using a repeater, so there are not multiple signals on which to triangulate. Repeaters tend to exacerbate the problem due to inherent delays which facilitate erroneous triangulation coordinates.

### SUMMARY OF THE INVENTION

It has been recognized that in CDMA (Code Division (or, Domain) Multiple Access) systems, pilot beacons are used for facilitating hard channel handoffs between carrier frequencies, and for hand downs from CDMA to other networks. By transmitting the pilot, page, and sync channels (PPS) as a guide for the mobile, the chance of a mobile completing a handoff between carrier frequencies is greatly increased.

It has been recognized that these signaling or hand-down pilot beacons are capable of being used for location determination, as they are part of the CDMA cellular network and have a unique PN offset. However, the pilot beacon signals are rarely or never used for ranging and location determination, because a pilot beacon is transmitted together with a CDMA traffic signal that already has a valid PN offset that also may be used for ranging. Furthermore there are several issues including the complexity of the additional signaling for cellular channel hand-down; some cellular signaling can cause a handset to try to “camp” on a pilot beacon, resulting in actions on contents of the signaling information. Another difference between a handoff pilot beacon and a pilot beacon described herein is that the pilot beacon used for location determination must transmit its RF signals on all channels simultaneously. Handoff pilot beacons sometimes frequency hop. As explained below in the Detailed Description section, the location determination timing is more stringent than handoff timing, thus requiring continuous pilot signals to work properly. Since the handset may be camped on any channel assigned for its use, the pilot beacon must transmit on those assigned channels.

The system and method of the invention provides a location or pilot signal which is combined with a communication signal at a ratio that both allows the handset to determine its location without interference from the location signal.

In one embodiment of a method of determining the location of a wireless handset, at least one repeating antenna is positioned in a location not capable of receiving a sufficiently strong signal from a carrier site to allow the handset to receive a communication signal. The signals from a radio frequency receiving device is repeated to the at least one repeating antenna. The signal from the at least one repeating antenna is repeated to the radio frequency receiving device. A location signal is provided. The communication signal and location signal are combined. The combined communication and location signal are transmitted from the at least one repeating antenna so that the handset can receive the signal and determine its position.

In an embodiment, the radio frequency receiving device is an exterior donor antenna. In an embodiment, the radio frequency receiving device is a base station.

In an embodiment, the positioning of at least one antenna is positioning at least two antennas. The location signal includes an offset signal to distinguish the at least one repeating antenna.

In an embodiment, the positioning signal includes a timing offset to adjust the timing of the position signal to reflect delays.

In an embodiment of a system for determining the location of a wireless device, the system includes at least one repeating antenna. The system has a radio frequency receiving device capable of receiving a communication signal from a carrier site. A positioning device in the system is capable of sending a positioning signal related to position of the positioning device. A coupler combines and feeds the positioning signal from the positioning device and the communication signal to the at least one repeating signal.

In an embodiment, the positioning device includes a GPS receiver and the at least one repeating antenna is at least two repeating antennas and the positioning signal is sent to each of the repeating antennas.

In an embodiment, the signal has an offset and a phase at each of the repeating antennas.

A method of the invention relates to determining the optimal level of pilot beacon signal. The strength of the repeated signal is measured. Information on acceptable pilot beacon/repeated signal strength ratios is obtained. The power of the pilot beacon and the repeated signal are set.

In an embodiment of a position signal circuit is a field programmable gate array (FPGA) and an input adapted to receive an external GPS signal for forwarding a signal to the FPGA. A repeater antenna coupler is adapted to communicate with at least one repeater antenna. The FPGA produces a timing signal for the at least one repeater antenna for assisting a wireless handset to determine the wireless handset's location.

In an embodiment, the FPGA produces an even second tick.

In an embodiment, the position signal circuit includes an external antenna coupler adapted to connect to an external donor antenna wherein the FPGA process the communication signal both in an uplink direction and a downlink direction.

In an embodiment, the position signal circuit includes a Temperature Compensated Voltage Controlled (X) Crystal Oscillator and a phase locked loop to generate a stable time reference for the pilot beacon signal.

In an embodiment, the FPGA generates two bands of pilot beacon signals.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a pictorial display of a building have an outside antenna and a repeater to several internal antennas;

FIG. 2 shows a schematic of a handset positioning system;

FIG. 3 shows an example of a spectrum in the building versus power;

FIG. 4 shows a schematic of an alternative handset positioning system 70;

FIG. 5 shows a schematic of a band rejection filter for the positioning signal;

FIG. 6 shows a schematic of an alternative embodiment of the handset positioning system;

FIG. 7 shows a schematic of the net filter response of the embodiment shown in FIG. 6;

FIG. 8 shows a pattern from an omni antenna and a yagi antenna;

FIG. 9 shows a schematic of a flow chart of a method to determine levels of power of the signals;

FIG. 10 shows a schematic of uplink and downlink from the outside antenna to the inside antenna;

FIG. 11 is a schematic of a circuit for feeding the pilot signal;

FIG. 12 is a schematic of an alternative embodiment of a circuit for feeding the pilot signal;

FIG. 13 is a schematic showing several alternative locations for a location or pilot beacon signal to be summed with communication (traffic) signal;

FIG. 14 is a schematic of a system with a head end unit and at least one remote unit and the location or pilot beacon signal being summed after the end unit;

FIG. 15 is a schematic of a GPS positioning signal system;

FIG. 16 is a handset positioning system shown with a pair of pilot beacon signals used with a single repeater;

FIG. 17 is a graphical representation of the pilot beacon signal power in relation to the communication (traffic) signal; and

FIG. 18 is a graphical representation showing the pilot beacon signal needing to be adjusted not to be masked by communication (traffic) signal without a pilot beacon signal.

### DETAILED DESCRIPTION OF THE INVENTION

A system of and method for accurate positioning, which is location determination, of a wireless handset combines a positioning signal with the communication signal. For locations where a wireless handset cannot receive an adequate signal, such as inside a building, the system receives a carrier signal either through a donor antenna, on the exterior of the building, or a base station connected to the carrier. The system rebroadcasts the carrier signal over one or more repeating antenna. In addition to a communication signal, the system adds a location signal to assist the wireless handset in determining the wireless handset's location. The power level of the location or positioning signal, a pilot beacon signal, is adjusted so as to be sufficiently strong that the wireless handset will receive the signal, but not at a level that will cause interference with the communication signal. The system takes the pilot beacon signal from a different source and/or uses a different path than the communication signal to minimize delays. In addition, the system adjusts the offset, either positively or negatively, to account for timing delays caused by hardware and cables. The pilot beacon signal can have multiple channels so that each repeating antenna has a distinct pilot beacon signal and the wireless handsets can determine the handset location.

While abbreviations will be given the first time they are used, for ease, the following is a list of abbreviations used:

AFLT—Advanced Forward Link Trilateration is a type of handset-based position location technology. Unlike A-GPS, AFLT does not use GPS satellites to determine location. To determine location, the phone takes measurements of signals from nearby cellular base stations (towers) and reports the time/distance readings back to the network, which are then used to triangulate an approximate location of the handset. In general, at least three surrounding base stations are required to get an optimal position fix.

A-GPS—Assisted GPS—is a process wherein the use of terrestrial-based location methods improves the speed and accuracy of handset GPS satellite-based positioning. For example, terrestrial-derived information that provides approximate location may be used to reduce the time to find weak satellite signals in the handset.

BDA—bi-directional amplifier.

BNC—Bayonet Neill-Concelman connector—a type of RF connector.

BTS—base transceiver station—a unit that facilitates wireless communication between handset and the carrier station. In the non-repeater deployment, the Distributed Antenna System (DAS) is coupled to a Base Station directly using coax or fiber optic cable. For example, a wireless provider may install a base station in the basement of a building to feed the DAS in the building.

CDMA—Code Division (or, Domain) Multiple Access.

DAS—Distributed Antenna System.

EST—Even Second Tick: In the CDMA cellular system all time values are referenced to the start of the even seconds of time as indicated by GPS.

FPGA—field-programmable gate array.

GPS—Global Positioning System.

HILBERT—A Hilbert function allows a baseband or intermediate frequency signal to be separated into quadrature components, facilitating the up-conversion and generation of a single side-band passband signal, with a greatly reduced unwanted image.

PDE—Position Determination Entity.

PN—Pseudo random Number: A number chosen by sole algorithm that approximates a random process.

PN Number—In the CDMA system, a subset of the possible PN Offsets that are used for the base station identification. Each of these allowed offsets are given a unique number from 0 to 511.

PN Offset—same as PN Number.

PN Sequence—The coded repetitive signal time sequence developed for use as a pilot signal. The PN Sequence signal is offset in time from a time reference by the PN offset.

PPS—Pulse per Second.

RF—Radio Frequency.

SMA—SubMiniature connectors—a type of connector used with RF coaxial cables.

Tau (τ)—Timing Offset or Delay Adjustment—the timing of the downlink signal is required to be aligned with the EST as it is transmitted from the antenna in CDMA. Tau allows the timing of the internal PN Sequence to be adjusted to compensate for the delays of the base station hardware such that the timing will be correct at the antenna.

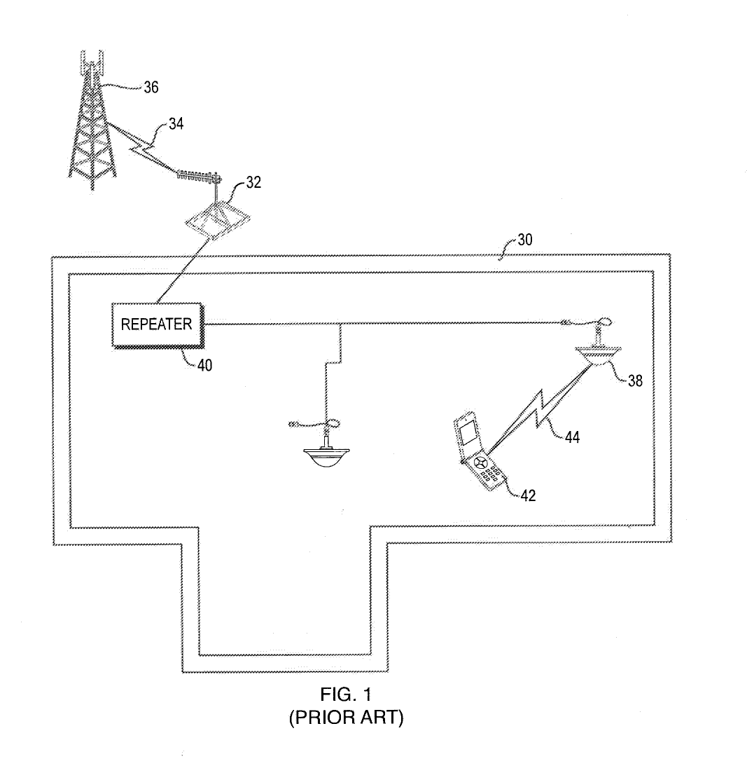

Currently, pilot beacons are primary used by CDMA carriers for facilitating hard hand-offs. Referring to FIG. 1, a building 30 has an antenna 32 outside of the building 30 for receiving signals 34 from a carrier site/tower 36 is shown. The antenna 32 is connected to at least one antenna 38 located inside the building 30 via a repeater 40. A handset 42 located in the building 30 is capable of receiving a signal 44 from one of the at least one antennas 38.

As indicated above, the number of indoor repeater applications has increased greatly in the last several years. In indoor applications, the normal methods used for location determination, direct reception of GPS by the mobile station or triangulation using the signals from multiple base stations, do not work. Signals from the GPS system are sufficiently weak that even if the mobile station's GPS receiver might ultimately be able to lock on to the satellites, the acquisition time will be too long. And since indoor service is typically provided either by a single strong local cell or by using a repeater, there aren't multiple signals on which to triangulate. Repeaters tend to exacerbate the problem due to inherent delays which facilitate erroneous triangulation coordinates.

A repeater used in a CDMA system to enhance coverage in poor propagation areas typically adds significant delay to the link between the handset 42 and the base station. This delay is typically due to the bandpass filter used to select specific channels to repeat. If the delay is excessive, there is a likelihood that location-based services and E911 will not work properly, as signals are presented to the handset from the repeater and from the macro network simultaneously. The combination of these signals causes large errors to occur in the estimation of position and the subsequent provision of assisting information to allow A-GPS to function well. For example, a macro signal with correct delay is combined at the handset with a repeated signal with 2 microseconds of delay, in one repeater scenario. The 2 μs delayed signal represents an error in estimating distance of approximately 2000 feet. In a hybrid GPS/CDMA/A-GPS location determination system, an accurate estimate must be provided to allow GPS correlators in the handset to receive very weak GPS signals. The 2000 foot error prevents the GPS correlators from converging on a good peak, as the correlation windows are offset by the equivalent of a 2000 foot error.

To address the repeater application, a wireless provider might wish to disqualify from AFLT fixes any base station that has a repeater. However, this solution is problematic because it is undesirable to remove a macro donor site from the Base Station Almanac's AFLT-allowed base station list. The problem arises because the same donor site is providing position references to customers not served by the repeater. If the network “disqualifies” a particular macro site from participating in location determination (i.e. does not allow the particular macro site from participating in AFLT), then many handsets in the macro network that are listening to this particular macro base station will not be located. The wireless provider and the handsets cannot tell the difference between a handset in the macro network, and a handset within the building using a repeater. A solution to the need to improve A-GPS is required and is described herein.

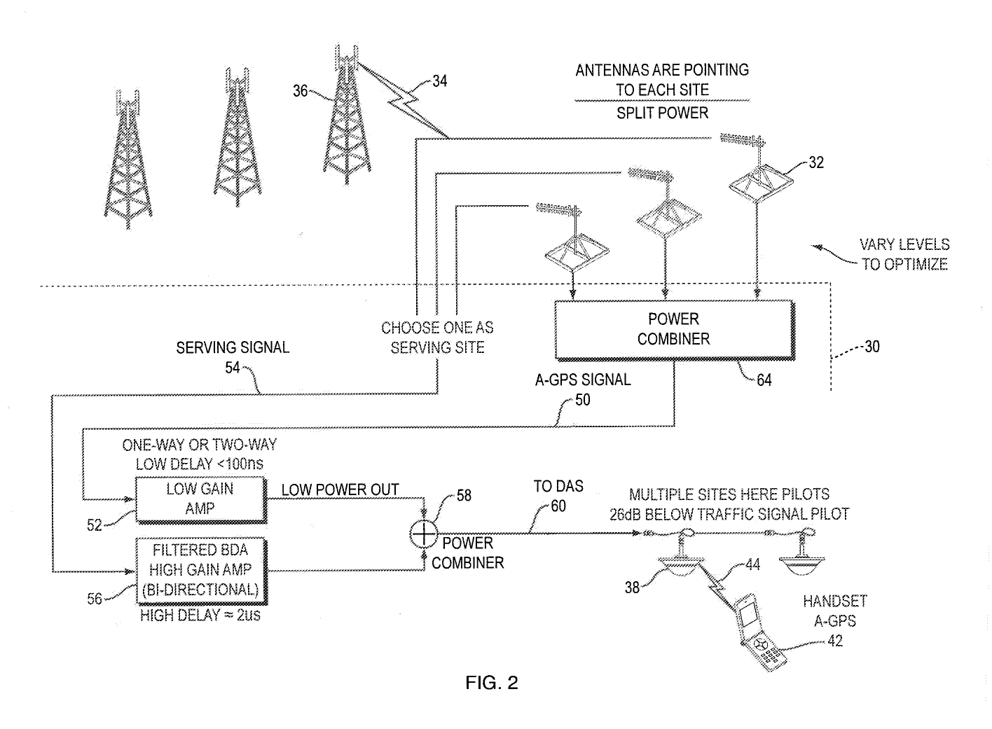

Referring to FIG. 2, a schematic of a handset positioning system 20 is shown. The system 20 has at least one external antenna 32 located, such as outside the building 30, for receiving signals 34 from the carrier tower 36. In contrast to a conventional system, the system 20 does more than repeat the communication signal to an interior antenna 38. The system 20 takes the signal 34 received outside and sends it through two paths wherein in one path 50 is through a low-gain amplifier 52 which will carry the location signal or position information and the other path 54 is through a high-gain amplifier 56 which carries the communication signal. The signals are combined at a combiner 58 and sent to a distributed antenna system (DAS) 60 having at least one antenna 38. The low gain, low delay amplifier 52 is a one-way amplifier. The positioning or location signal, the pilot beacon, is transmitting to the handheld and transmission is not required back.

As indicated above, the handset 42 uses A-GPS or Advanced Forward Link Trilateration (AFLT) to speed up the determination of the location of the handset 42. In A-GPS, outside sources, those not within the handset 42, help the GPS receiver in the handset in determining the proper location. The outside sources can provide varying levels of information including orbit and clock information or initial position and time estimates. In contrast to A-GPS, AFLT does not use GPS satellites to determine location of the handset. In contrast, AFLT determines the location of the handset 42 by taking measurements of signals from nearby cellular base stations (towers) and reports the time/distance readings back to the network, which are then used to triangulate an approximate location of the handset. In general, at least three surrounding base stations are required to get an optimal position fix.

As indicated above and will become clearer below, the mere sending of the same location data to multiple antenna 38 does not facilitate locating the handset 42. Furthermore, if the handset 42 is basing the location off of the position of the external antenna 32, the position will not be accurate.

With respect to the handset 42 attempting to determine its position using a Global Positioning System (GPS) signal, the signal needs to be strong enough without interference such as bouncing of waves to determine the position. It has been recognized through testing that long delays, e.g. 2 μs, result in slow or non-existent acquisition of the GPS. By supplying multiple signals from multiple sites, A-GPS will calculate information to provide GPS with a better first fix.

It is recognized that many handsets within a building are capable of receiving some GPS signals, because the newer handsets use very sensitive receivers that have very long correlators. In basements and heavily shielded areas, the handsets are certainly not able to receive the satellite signals. However, when they can, these long correlators are always benefited by information about “approximate” location to “search” the GPS signals and receive them. AFLT provides this “approximate” location. Then the handset does the work to “pull the weak GPS satellite signals out of the mud”, using the approximate location information provided by AFLT. One problem with a repeater is that it transmits signals that are time offset, and thus, a handset receiving repeater signals is “offset in time” due to their signal delay. Therefore GPS correlators when using AFLT information through a repeater search in the “wrong” time-window, and take longer to detect the very weak GPS signals.

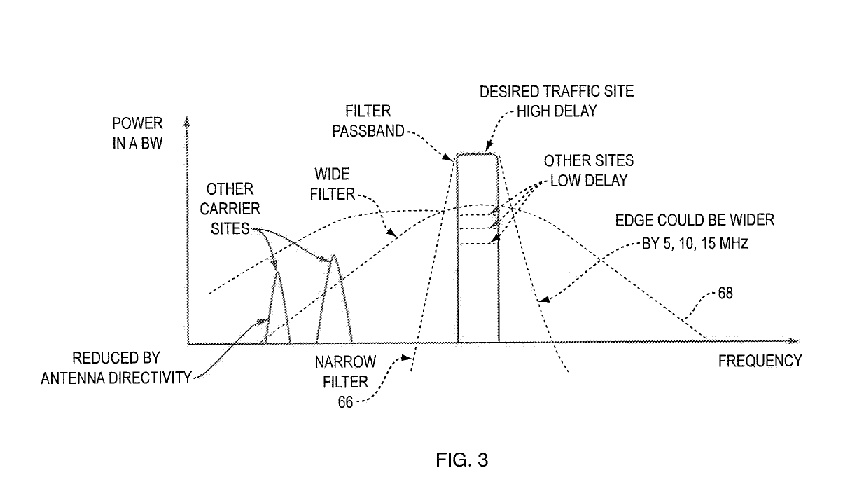

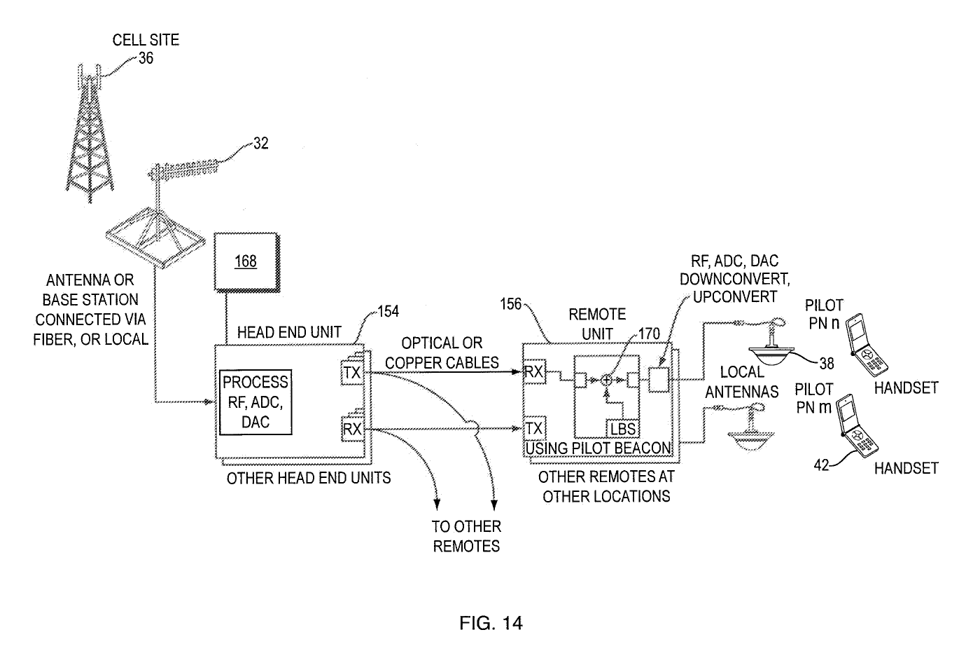

With a brief description of the handset positioning system 20 described, additional details regarding the system and theory are described to further amplify how multiple antennas each with a particular position signal are used to allow the handset 42 to determine its location. Referring to FIG. 3, an example of a spectrum in the building versus power is shown. In a system 20 that uses AFLT to determine the position of the system, the system 20 wants to maximize the signal from the desired carrier tower 36, as seen in FIG. 2, used for communication and reducing competing signals but at the same time receiving sufficient signal for positioning. The narrow or sharp filter as represented by dash line 66 in FIG. 3 and block 56 in FIG. 2 receives the communication signal (traffic signal) but results in a high delay that is not beneficial in positioning for the reasons discussed above. The wide filter as represented by dash line 68 in FIG. 3 and block 52 in FIG. 2 has a low delay which facilitates better precision on the location of the handset. The “wide filter” may be “very wide” out to the limits shown in the dashed line at the left side of the figure. The extent of the passband depends on the rejection requirements of the other carriers' signals, shown to the left in the figure. Wider filter bandwidths always provide lower delay which is beneficial for position accuracy. As will be discussed below with respect to FIG. 14, that embodiment shows what is likely a more accurate location determination.

The amplifiers as represented by blocks 52 and 56 in FIG. 2 can be implemented using digital techniques. Another option is to use an analog system for the low delay (positioning signal) and digital for the high delay needing the sharper filter for the bi-directional amplifier (BDA).

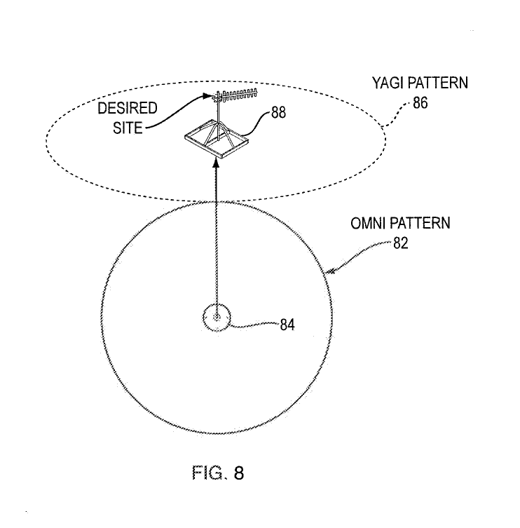

Referring back to FIG. 2, the attenuators at block 64 may be allocated to equalize the signals from the sites while reducing the other-carrier sites signals. An alternative to a separate Yagi's pointing to each site is to use an omni directional antenna. FIG. 8, which is described in more detail below, shows the pattern 86 for Yagi antenna 88 which is a directional antenna system consisting of an array of a dipole and additional closely coupled parasitic elements. The pattern 82 for an omni antenna 84 is also shown which radiates power uniformly in one plane, with the radiated power decreasing with the elevation angle above or below the plane, dropping to zero on the antenna's axis.

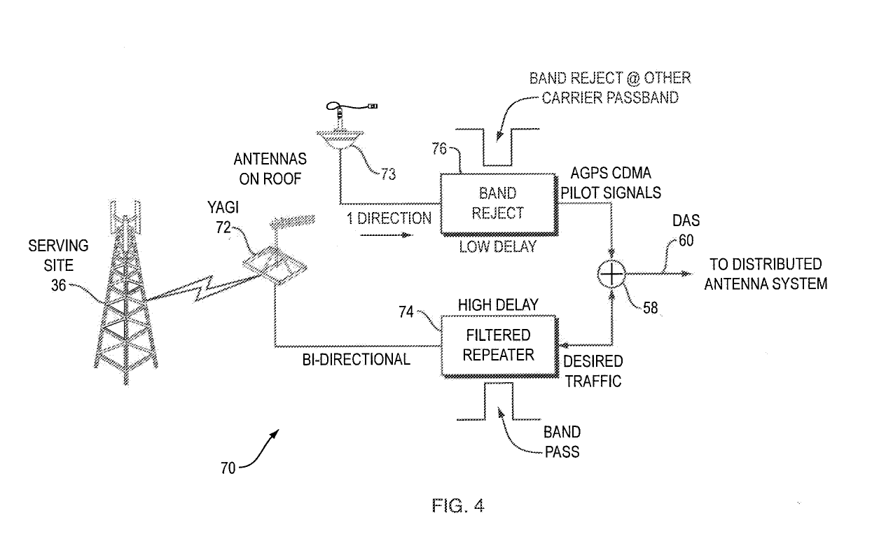

While FIG. 2 shows a signal being split between the repeater 56 with high delay for the communication signal and the low gain amp 52 with low delay for the position signal, it is recognized that the position signal can be acquired by different means. Referring to FIG. 4, a schematic of an alternative handset positioning system 70 according to the invention is shown. The system 70 has an (yagi) antenna 72 which is in bi-directional communication with a carrier site 36. The antenna 72 is also in bi-directional communication with a repeater 74. In addition, the system 70 has a second antenna 76 for receiving positioning data. The signal is sent to a band reject filter 78. The wide band and the band reject only need to provide a relatively weak signal in contrast to the communication signal, and thus it is okay to allow a little unwanted signal to “leak” in. In addition, in the embodiment shown, the donor antenna 72 on the roof is directional and “spatially rejects” the unwanted signals, making the level of unwanted signals even lower in the building. In addition, in contrast to the communication signal, the location signal or position information is only in one direction and low delay.

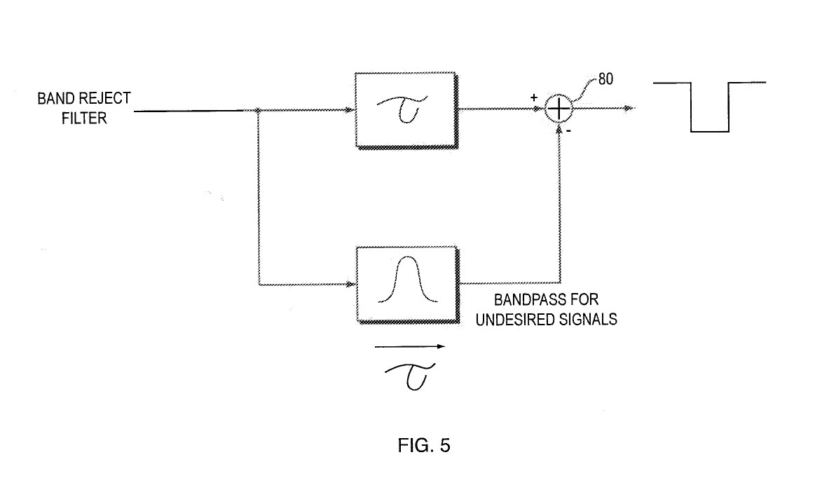

A low-delay digital filter selectively rejects the undesired signal. This is in contrast to using a filter wide enough to pass the signals. The low delay, lower power amplification can be a band-rejection filter to reject the other carrier's signals from being retransmitted in the building. Referring to FIG. 5, a schematic of a band rejection filter for the positioning signal is shown. The band rejection filter may be implemented using a digital filter. The filter subtracts the undesired frequency ranges. Depending on the offset between the desired and the undesired signals, the delay in the A-GPS amplifier may be very low. The band rejection filter has a combiner 80 that is used to combine portions of the signal in the band rejection filter. This is in contrast to the combiner 58 in FIG. 4 used to combine the low delay path and the communication (repeater) path.

Referring back to FIG. 4, similar to FIG. 2, the two signals, the communication signal and the position information, are combined at the combiner 58 and sent to the distributed antenna system 60.

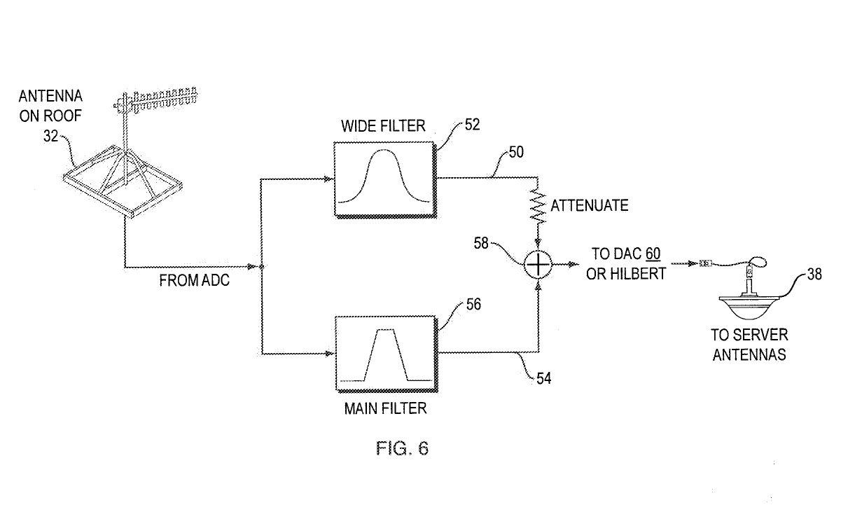

Referring to FIG. 6, a schematic of an alternative embodiment of the handset positioning system is shown. The system has a (yagi) antenna 32 which is bi-direction. The analog signal is converted into a digital signal. The signal is sent to two filters. The main filter is for filtering the communication signal, the main signal. The other filter is for passing the positioning information. This signal is sent through an attenuator to reduce the signal before being combined with the communication signal. The combined signal is sent through a digital-to-analog (D/A) convertor before being sent to the server antenna.

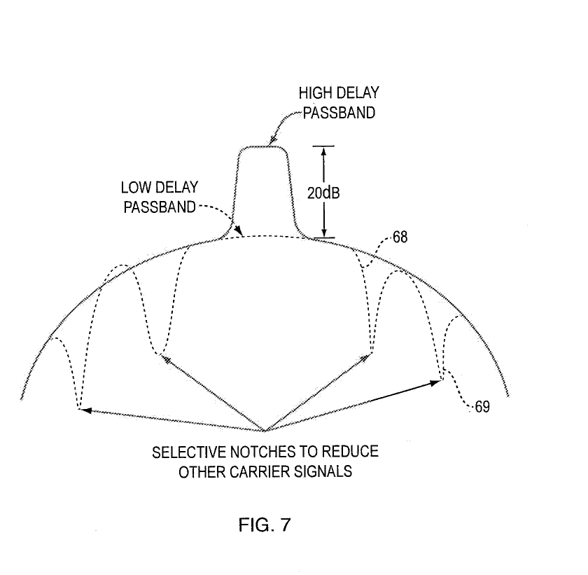

Referring to FIG. 7, a schematic of the net filter response of the embodiment shown in FIG. 6 is shown. The solid line is the signal through the main filter. The dash line is the signal through the wide filter 68. The wide filter 68 can include selective notching 69 to reduce other carrier's signals.

It is recognized that the system 20, 70 can take the attributes of various styles of antennas to get both the communication signal and a position signal. For example, the embodiment in FIG. 4 shows two types of antennas. Referring to FIG. 8, a pattern 82 from an omni antenna 84 and a pattern 86 from a yagi antenna 88 are shown. The outside (roof top) antenna 32, such as seen in FIGS. 2 and 4, could have a pattern that provides for the different levels of Yagi desired and omni signals. The Yagi antenna is directed towards the desired signal, the desired carrier signal 36.

As indicated above, the system 20 splits the signal prior to filtering. A repeater used in a CDMA system to enhance coverage in poor propagation areas typically adds significant delay to the link between the handset and base station.

In situations where the handset 42 is not receiving a strong GPS or multiple carrier tower signals, another means is required to provide location information to the correlators in the handset 42. The system 20 uses the additional position signal as represented by the position path 50 in FIG. 2 as this other means. The positioning information, a pilot beacon, is an additional source of location information. The position determination entity, a processor within the overall system, provides location information to the handset and to other entities requiring position information. Typically, this processor is connected to the Internet. The position determination entity calculates location based on handset 42 reported information, and may be programmed to provide specific location information to the handset 42 based on the reception of the pilot beacon by the handset 42. This specific location information is then used by the handset 42 to allow fast convergence of the GPS algorithm. The GPS sensitivity has been improving over time, as longer correlators have been installed in handsets 42. Accurate location information can then be obtained and provided to the network for location based services or E911.

However, the pilot beacon technology used in CDMA cellular networks for handoff cannot be used. While pilot beacons can be part of the CDMA cellular network and have a unique PN offset as indicated above in the Summary of the Invention section, there are issues such as trying to “camp” on a pilot beacon that prevents it from being used as it exists for location determination as in the system 20.

The pilot beacon in addition can act as an interference source to the repeated signals. There is a range of levels that optimize the use of the pilot beacon signal. If the level of the signal is too low, the handset 42 will not see a reliable beacon signal 94, which is part of the combined signal with the communication signal sent from the interior antenna 38, particularly if there are other strong pilots present. If the signal is too high, interference will result to the pilots associated with carrying voice traffic, and other communication traffic such as text and data. The system 20 and 70 has a unit 96 which contains both the repeater 56 and 74, such as seen in FIGS. 2 and 4, and the low delay filter for the position signal. This unit 96 is inherently able to control the level of a self-generated pilot beacon with respect to repeated signals since both the communication signal and the position signal are available and may be measured. Therefore, an algorithm may be used to determine the optimum level of the pilot beacon signal.

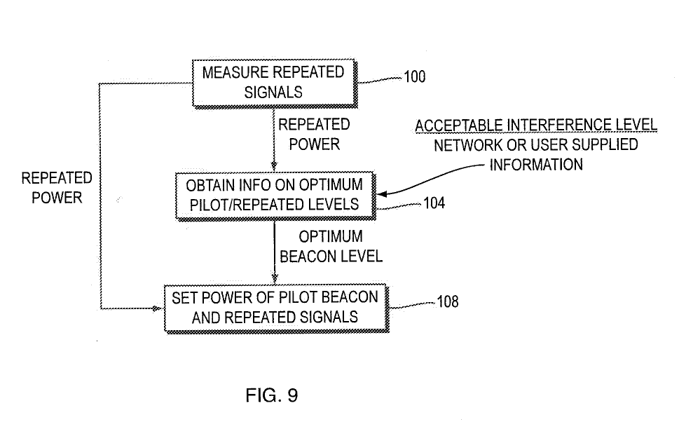

Referring to FIG. 9, a schematic of a flow chart of a method to determine levels of power for the position signal is shown. The communication signal, the signal to be repeated, is measured as represented by block 100. Information regarding the desired ratio of the pilot beacon signal to the communication signal is gathered as represented by block 104. The accepted levels, the interference levels, can come from various sources including the network or user. Based on the information, the system 20 and 70 sets the power of the pilot beacon 94 and the communication signal, the repeater signal, as represented by block 108.

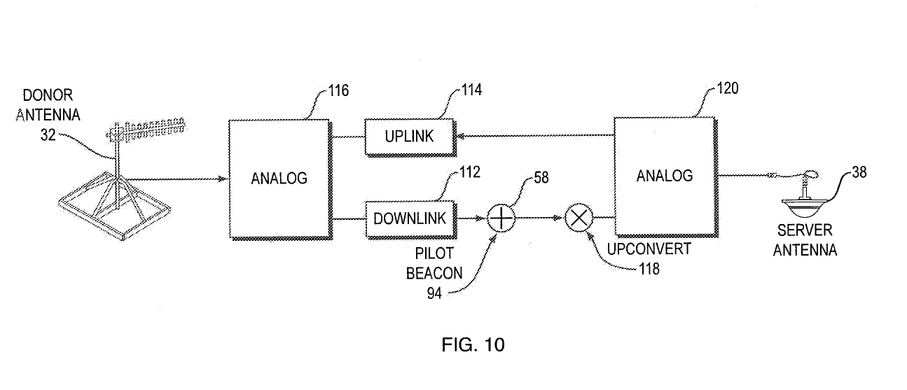

Referring to FIG. 10, a schematic of uplink and downlink from the outside antenna 32 to the inside antenna 38 is shown. The outside antenna 32 is receiving the signal from the carrier tower 36 and the system 20 is retransmitting the signal with the position signal to the inside antenna 38. In addition, the system 20 needs to transmit information from the handset 42, such as seen in FIG. 2, to the carrier tower 36. The system therefore has a downlink 112 for manipulating the signal to the handset 42 and an uplink 114 for manipulating the signal from the handset 42. The antenna, the outside antenna, 32 receives a radio signal, an analog signal as represent by block 116. The signal manipulation can include converting the analog radio signal to a digital signal using an analog to digital converter, converting the frequency range to assist in manipulation, and filtering of the signal to eliminate non-desired signals which are represented by the downlink block 112 in this Fig. A position indicating signal, a pilot beacon signal 94 is added to the processed communication signal at the combiner 58. This combined signal is further processed and up converted to the initial frequency of the radio signal as represented by the circle 118. The radio signal is transmitted by the internal antenna 38. While the signal being transmitted over the airwaves is analog, it is likely the signal is converted to digital in an analog-to-digital converter (A/D converter) prior to the down link and converted from digital-to-analog in a D/A converter prior to the internal antenna 38 as represented by block 120. In that the communication is bi-directional, a communication signal received by the inside antenna 38 is retransmitted on the outside antenna 32 through the uplink 114.

One implementation of the system is to provide separate filters for each RF channel to be repeated and adding the RF signal at the IQ baseband, on each RF Carrier. The unit 96 that processes the signals can have a field-programmable gate array (FPGA) to implement the pilot beacon signal 94, as well as the filters for the channels to be repeated, the communication signals.

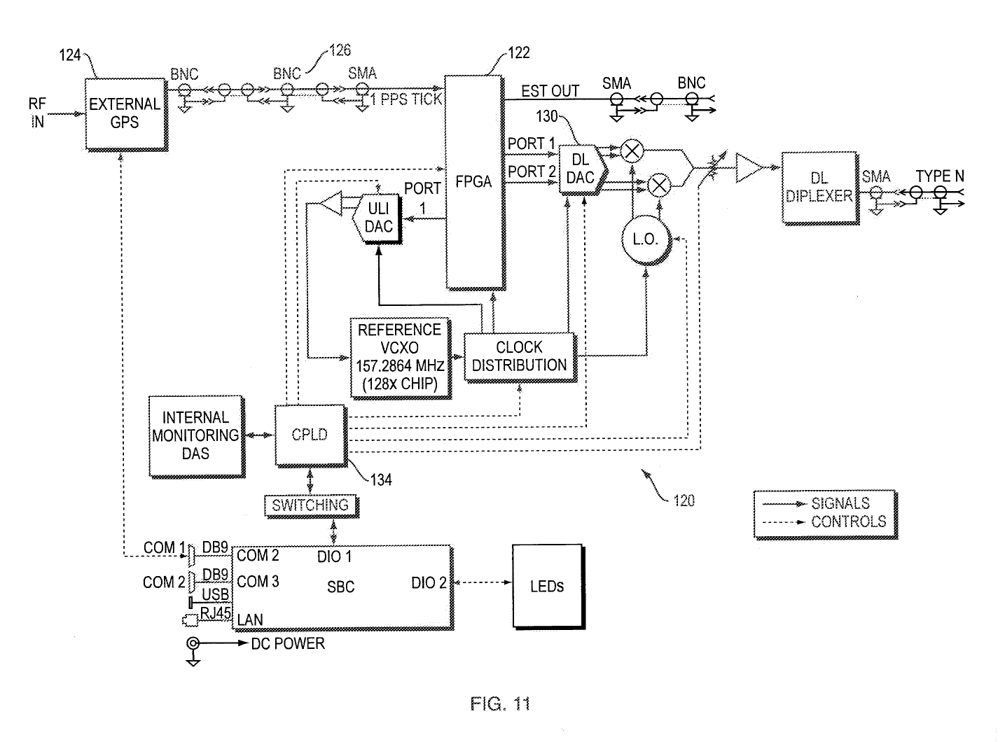

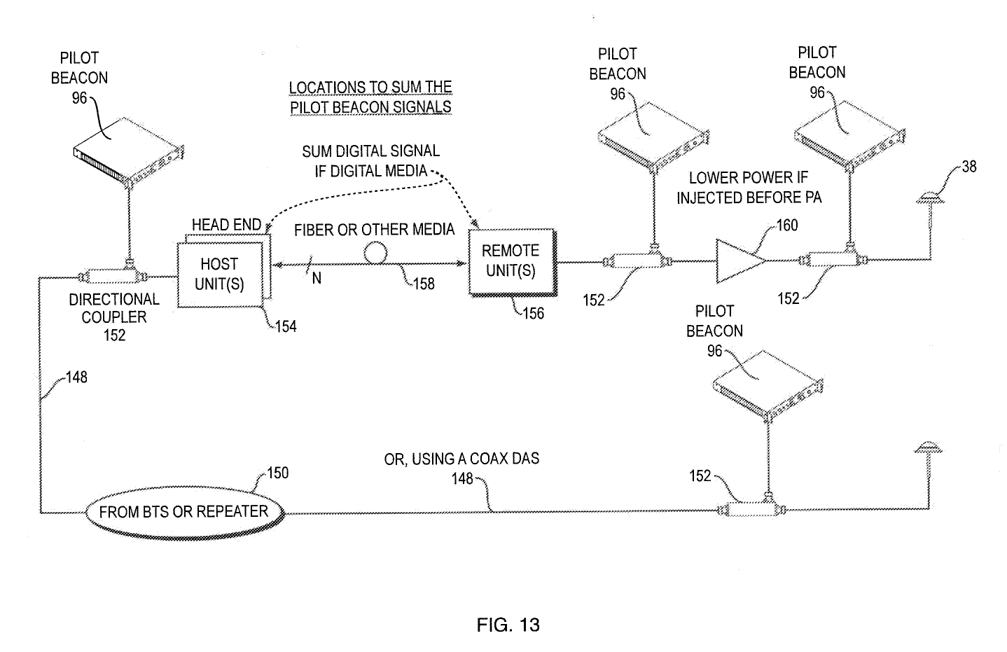

Referring to FIG. 11, a schematic of a circuit for feeding the pilot signal is shown. The unit 96 has a circuit 120 with a FPGA 122 with digital hardware to produce the pilot signal, modulated with spread spectrum as described in CDMA IS-95 or IS-2000. The unit 96 receives a timing signal from an external GPS as represented by block 124 that is connected to the unit 96 through a cable and connectors as represented by 126. The timing signal includes a one pulse per second (1 pps) tick. Or, the timing signal may be a pulse or time tick generated every two seconds; this is referred to as a 0.5 pulse per second (PPS) signal. The digital signal generated in the FPGA 122 is applied to a digital-to-analog converter as represented by the down link DAC block 130 for conversion to an analog signal. The analog signal may be a baseband signal that has I and Q components to facilitate single-sideband up-conversion. Alternatively a single signal can be applied to the up-converter with filtering to reduce the unwanted conversion sideband. The up-converted signal is applied to an amplifier and attenuator combination, such as shown in FIG. 13. The signal is then applied to the DAS, or to an antenna.

While not shown, the communication signal, both the downlink and the uplink, is processed through the FPGA 122. The communication signal is applied to an ADC, FPGA digital filter, and then a DAC, all cascaded.

Referring back to FIG. 9, the attenuator is set so the pilot beacon output power is optimized for the traffic signal power that is present. The algorithm to set this power level was described above.

As indicated above, timing is a critical component for the handset 42 in location determination. Therefore the timing accuracy of the pilot beacon signal 96 is of paramount importance, because timing errors contribute directly to location errors. A critical aspect of the design of a stable timing reference is a stable internal or external frequency reference that is time synchronized. The circuit 120 in the system 20, 70 uses an internal phase locked loop to provide a stable timing reference to the FPGA 122. The phase-locked loop (PLL) may be entirely located in either type of device, FPGA or CPLD, or, some of the functions may be performed in each device, such as conditioning of the timing pulse performed in a CPLD, while the timing feedback loop may be calculated in the FPGA. The externally applied timing pulse, usually a half-pulse per second, received from a GPS receiver timing output, is used as the reference in a digital feedback loop to lock a Temperature Compensated Voltage Controlled (X) Crystal Oscillator. (TCVCXO) 136. By providing this feedback loop within the circuit 120 of the system 20, 70, timing sources that have worse short-term stability may be used as a timing reference. For example, the low cost Garmin GPS-18x has somewhat higher short term phase fluctuations as compared to a stable oven controlled reference. The signal is stabilized by the use of an internal loop. Another advantage of the internal feedback loop is the ability to detect an out of lock condition. This may happen when the GPS timing reference is present but has drifted significantly in phase, as might be the result of fewer satellites or a weaker GPS signal to the receiver. The precise timing of the output PN sequence is determined by the timing of the reference, together with an offset usually referred to as tau. The tau setting in the system 20, 70 may be adjusted positively or negatively from zero offset to account for offsets in the GPS timing reference, delays in the RF cables between the pilot beacon and the pilot beacon's antenna, though a DAS, and delays within the pilot beacon hardware itself. When used with a repeater, the tau is usually is set to a value that provides an accurate time reference relative to the macro network.

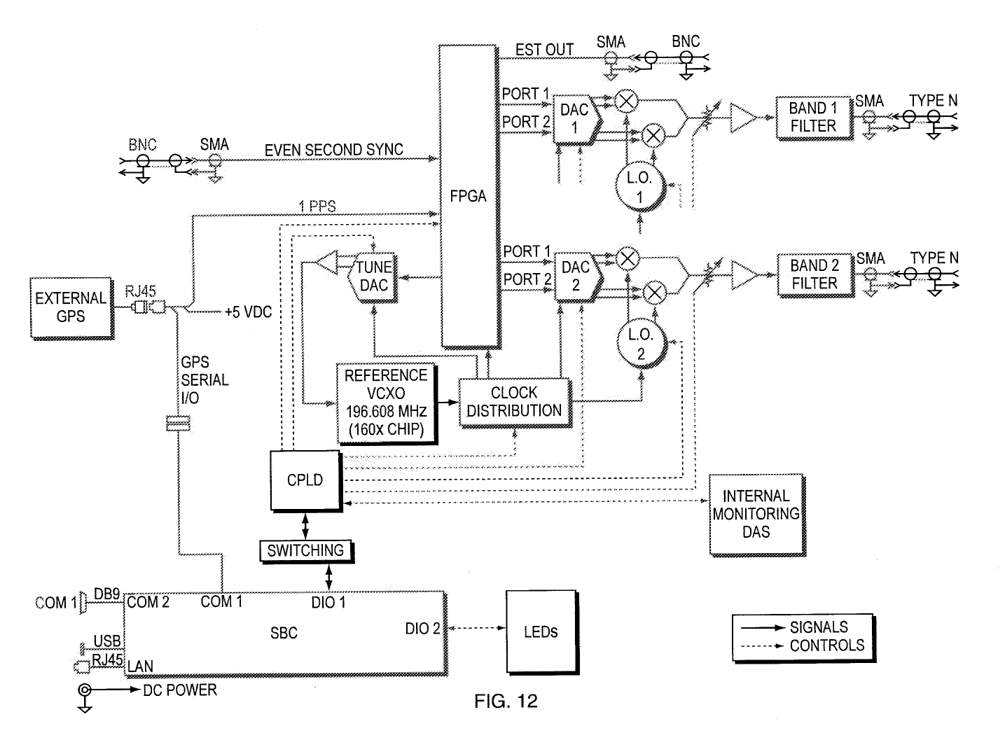

The FPGA 122 in the circuit 120 in the system 20, 70 can be used to provide one or more pilot signals 94 within a single FPGA 122. For example, a single FPGA 122 can generate the signals required for multiple channels in the cell band and multiple channels in the PCS band, for example. Each pilot signal 94 may have multiple channels. Multiple pilot signals may be generated in the same band of frequencies with different PN offsets. For example, a pilot signal can be generated in the cell band and have six CDMA channels with a PN offset of 12 and the same channels can be generated with a PN offset of 25. The two pilot signals may be combined before output, or supplied at separate outputs such as shown in FIG. 12.

In CDMA systems, timing is based on the occurrence of the start of an even numbered second of time as indicated by GPS. Note that time is defined as GPS Time not UTC. These two will differ by a changing number of leap seconds. The handset positioning system 20, 70 can use the even second tick from the GPS through the CDMA when available. However when the handset positioning system 29, 70 is using a GPS receiver, such as 124 in FIG. 11, which does not output an even second tick but rather a pulse at every second, the pilot beacon system needs to set and maintain an internal even second timing reference.

The above has indicated various techniques for obtaining a positioning signal, such as an external GPS antenna or triangulation. In addition, the timing issues have been described above including the requirement of an offset, tau, to compensate for delays because of cable lengths and circuitry.

The position signal, the pilot beacon signal, may be deployed with an indoor or outdoor distributed antenna system (DAS) 60 in a number of ways, depending on the presence of a repeater. As indicated above, a repeater usually receives a signal off-air from a cell site using a donor antenna. In the non-repeater deployment, the Distributed Antenna System (DAS) is coupled to a Base Station directly using coax or fiber optic cable. For example, a wireless provider may install a base station in the basement of a building to feed the DAS in the building. Or, the wireless provider may install a repeater to receive a signal off-air from a local cell site, and the output/input of the repeater is connected to the DAS, providing two-way connectivity back to the outdoor cell site.

The pilot beacon signal 94 in the handset positioning system 20 may be injected into the traffic signal path 202 at the head end of a DAS, at the remote antenna end of the DAS, or may be incorporated into the digital or analog hardware at each end of the DAS link. For example, a pilot beacon signal 94 may be generated in the digital hardware at the head end that has digitized the RF traffic signals. Similarly, the pilot beacon signal 94 may be generated in the digital hardware in the remote antenna node and transmitted out from the remote antenna 38 together with the traffic (communication) signals. Alternatively, the pilot beacon signal 94 may be generated in separate digital hardware and be summed into the digital signal path of the DAS at the head end, at the remote, or into the input of a power amplifier in the remote. It may be advantageous to sum pilot beacon signals into the input of a power amplifier because lower power levels are required by the pilot beacon.

Referring to FIG. 13 a schematic showing several alternative locations for a location or pilot beacon signal to be summed with communication (traffic) signal is shown. The communication or traffic signal is sent from a base transceiver station (BTS) or repeater, as represented by oval 150. The unit 96 that is the furthest to the left shows the pilot beacon signal 94 is connected with a directional coupler 152 at the head end 154. The head end 154 is connected to one or more remote units 156 by fiber or other media 158. The middle unit 96 is shown connected after the remote unit 156 and before a power amplifier 160. The final unit 96 on the top of the page, the furthest to the right in the FIG, is summed just before the antenna 38.

The upper part of FIG. 13 sums the pilot signal into an active DAS, one that has fiber optic cable, for example. The lower part of FIG. 13 shows summing into a coax DAS, that is passive and has no active components.

Referring to FIG. 14, a system 20, 70 with a head end unit 154 and at least one remote unit 156 is shown. The head end unit 154 receives the communication signal being forwarded from the carrier tower 36. Some processing of the signal can occur at the head end unit 154 including filtering out undesired communication signals. The communication signal is sent to the remote units 156. The location signal 94 is added at the remote unit 156.

In that the communication is bi-directional, the remote unit 156 sends a communication signal back to the head end unit 154 for re-transmission to the carrier tower 36. In a CDMA system, for example, a pilot beacon transmitter in each remote unit can transmit a PN code specific to each remote node. This allows LBS and/or E911 services the capability of determining the location of a call in progress. The pilot beacon transmitter may be implemented in the remote unit's 156 FPGA. A remote unit 156 in a DAS may have its own FPGA to provide signal conditioning and filtering, for example. The FPGA in the repeater is different from this remote FPGA. The pilot beacon signal may be generated in either FPGA.

Control of the register in the FPGA 122 may be done using signaling from the head end's 154 host computer 168. Alarming may be returned over the reverse link to the head end unit. Still referring to FIG. 14, the adder 170 shown in the FPGA 122 of the remote unit 156 sums the pilot beacon signal 94 into the locally transmitted signal. The level of the pilot beacon signal 94 may be determined by comparing the composite power setting of the down-line signal to the pilot beacon's necessary level and applying attenuation as described above with respect to FIG. 9.

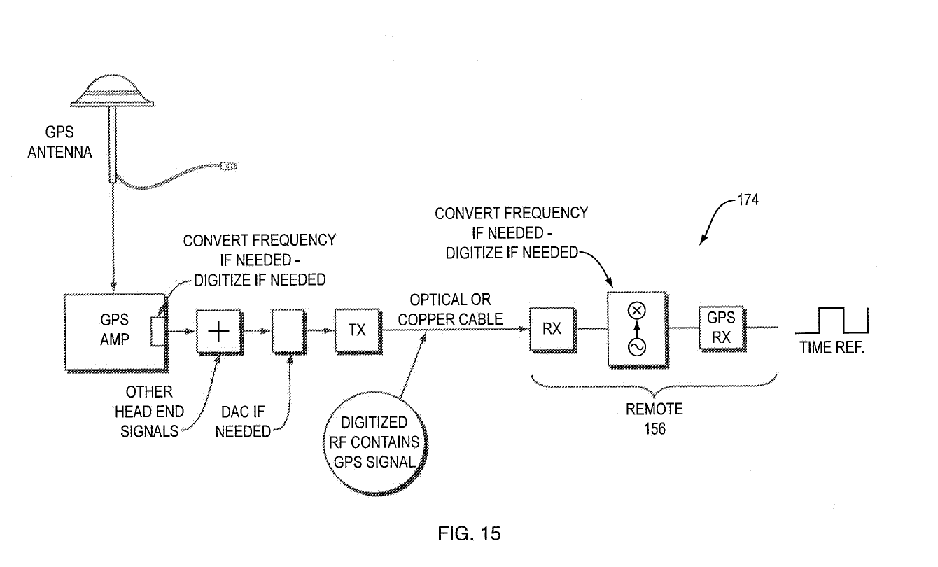

One solution to obtain timing information at the remote in a DAS is to transmit GPS in a “keyhole” method over the digitized RF in the DAS transmission media, to the remotes. Referring to FIG. 15, a schematic of a GPS positioning signal system 172 is shown. By doing this, time and frequency reference may be obtained at the remotes. The frequency reference for LBS or other purpose may bodied to the 1 pps (pulse per second) or 0.5 pps signal in the remote. A portion of the digitized RF contains the GPS signal, un-demodulated. The signal at 1.5 or 1.6 GHz, with a bandwidth of approximately a MHZ or so is applied to the digitized RF streamed and fed to the remote for reception.

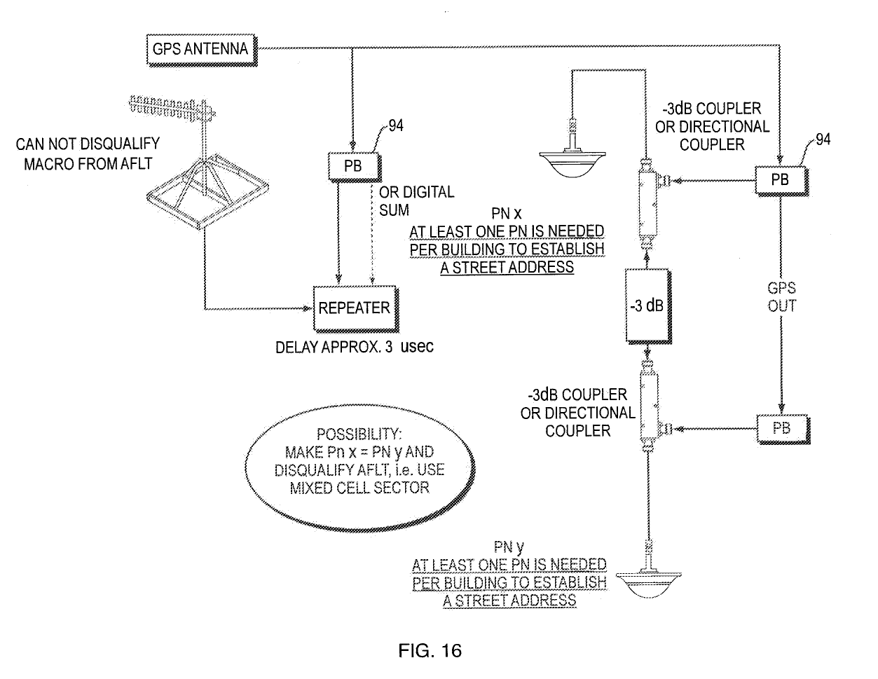

Referring to FIG. 16, a handset positioning system with a pair of pilot beacon signals 94 used with a single repeater is shown. When summing a pilot beacon signal with a repeater output signal, with or without a DAS, a pilot beacon signal may be generated separately and summed, or generated in the digital filtering hardware present in many repeaters. The pilot beacon can therefore be a separate summed signal source or may be contained within the DAS head end, DAS remote, or repeater. If the pilot beacon is standalone and generates its own RF signal, it will often be summed into the traffic signal path using a directional coupler. Signals can be summed at an Intermediate Frequency (IF) when a DAS uses an IF architecture, such as shown in FIG. 10 and described above.

A pilot beacon requires accurate timing information. A GPS receiver or other timing source is required to provide a time reference to the pilot beacon. Time references are well known in the art. For example, a GPS receiver may output a pulse that may be used to provide an accurate time reference. Alternatively, a nearby CDMA base station usually provides an accurate timing pulse output, synchronized to the GPS receiver signal received by the base station. There are other time synchronized signals that may be used to provide a time reference, such as the signals from the CDMA network itself. These CDMA signals are present at the head end, and at the remote end, and therefore these time references may be located at these locations. An example of a CDMA time reference is the Tycho CDMA time reference sold by EndRun Technologies, Santa Rosa, Calif. An example of a fully integrated GPS receiver and antenna that provides a timing pulse is the GPS-18x sold by Garmin International, of Olathe, Kans. Another solution to obtain timing information at a DAS remote is to pass a GPS signal in a “keyhole” method, over the digitized RF in the DAS transmission media to the remotes.

Referring back to FIG. 15, GPS digitized and sent to a remote location in combination with DAS signals is shown. A portion of the digitized RF contains the GPS signal, un-demodulated. The signals at 1575.42 MHz and/or 1227.60 MHz with a bandwidth of approximately 20 MHz are applied to the digitized RF stream and provided to the remote unit for reception. The GPS signal is converted back to RF at the remote, and is received by a GPS receiver and used to provide timing information. In any of the above timing methods, the frequency reference for the pilot beacon may be frequency or phase locked to a one pulse per second or to a half-pulse per second generated in the remote DAS node from a reference timing signal. Using time of day information supplied by the GPS receiver, an algorithm may convert a one second pulse into an even second pulse. The CDMA system is based on an even second time reference. The pilot beacon described herein uses one of a variety of timing source methods to establish time synchronization of the pilot beacon's PN sequence. In one embodiment of the invention, a timing signal may be daisy-chained to multiple pilot beacons. This eases the deployment of pilot beacons that may be distributed throughout a building, for example. One GPS signal may be applied to one pilot beacon and a timing signal sent from one pilot beacon to the next, etc.

Pilot beacons may be used in Distributed Antenna Systems (DAS) in a number of ways. DASs require remote nodes, also known as Antenna Units, that increasingly contain sophisticated functions such as filtering, sub-channel modulation, and frequency reference setting. In addition to these other functions it is helpful to add Location Based Services (LBS) capability to these remote nodes. The pilot beacon functionality may be added to the remote node to provide LBS. as shown in FIG. 14.

In a CDMA system, a pilot beacon transmitter in each remote unit can transmit a PN code specific to each remote node. This allows LBS and/or E911 services the capability of determining the location of a call in progress. The pilot beacon transmitter may be implemented in the remote unit's FPGA. Control of the registers in the FPGA may be done using signaling from the head end's host computer. Alarming may be returned over the reverse link to the head end unit. The adder shown in the block diagram of the remote unit eventually sums the pilot signal into the locally transmitted signal. The level of the pilot beacon may be determined by comparing the composite power setting of the downlink signal to the pilot beacon's necessary level and applying attenuation.

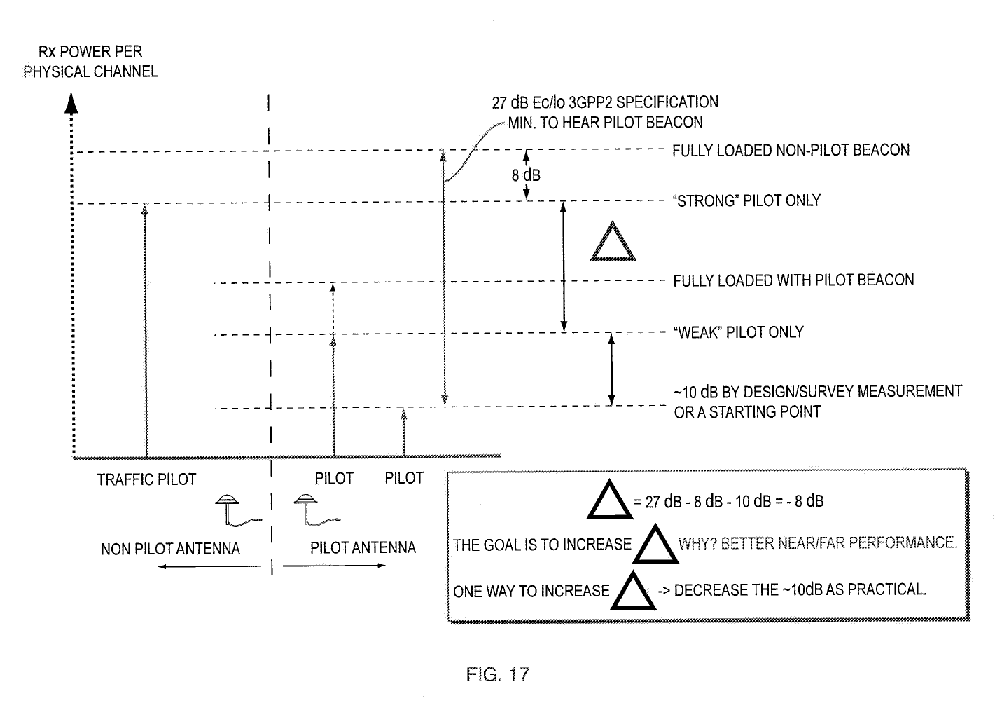

A particular problem of adjusting signal amplitudes is present when using pilot beacons, for example with a repeater. The pilot beacon can be an interfering source to the repeated signals. There is a range of pilot beacon levels that will optimize the use of the pilot beacon signal. If the level if too low, the handset will not see a reliable beacon signal, particularly if there are other strong pilots present. If the pilot signal is too high, interference will result to the signals associated with carrying voice traffic. Interference must be avoided, and therefore, the pilot signal power must be level-controlled or turned off altogether. A repeater is inherently able to control the level of a self-generated pilot beacon with respect to repeated signals, since the signals are available and may be measured. Therefore, an algorithm may be used to determine the optimum level of the pilot beacon signal. An example of this algorithm is shown and described above with respect to FIG. 9. Referring to FIG. 17, a graphical representation of the pilot beacon signal power in relation to the communication (traffic) signal is shown.

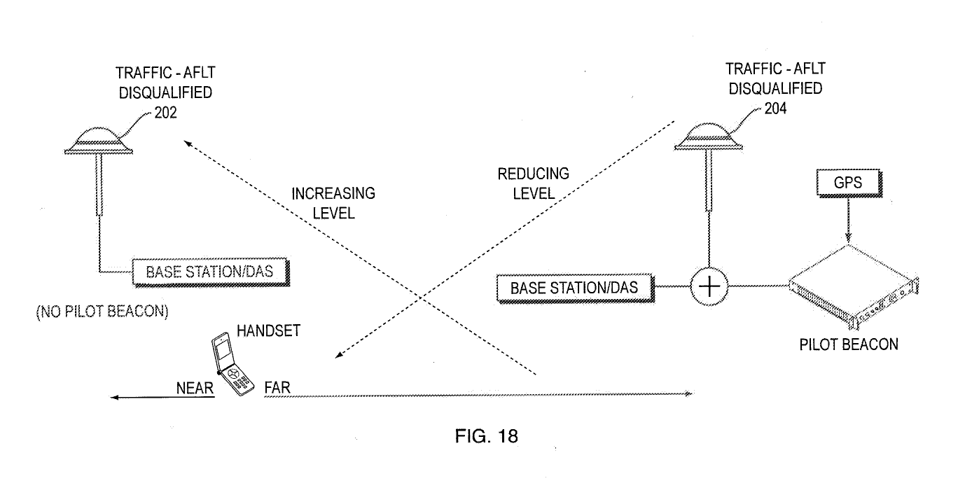

If the handset is too close to the antenna on the “left” side of FIG. 17, carrying only a traffic pilot, then the pilot beacon transmitted by the “right” antenna, with its traffic pilot, cannot be heard, because of the strong signal present from the antenna on the “left” side of FIG. 17. Therefore the handset is not able to determine its location when it is too close to the left antenna. The relative levels in the chart allow one to determine the effect of this. FIG. 18 is a schematic and FIG. 17 is more a graphically analytic.

It is important the pilot beacon power be adjusted to a power level high enough to not be masked by traffic signals that are not carrying a pilot beacon signal. Referring to FIG. 18, a graphical representation showing the pilot beacon signal needing to be adjusted not to be masked by communication (traffic) signal 202 without a pilot beacon signal is shown. The traffic signal 202 is strong when the handset is near its antenna. The pilot beacon must be adjusted so that location may be adequately determined when the handset is near the traffic antenna. When the handset is near the pilot plus traffic antenna 204, the pilot signal is strong enough to be received, and location is properly determined. It is important that the pilot beacon not output a power level that causes an interference coverage hole. For example, if the traffic is not summed into the pilot antenna 204, then a traffic coverage hole will exist when a handset is very close to the pilot-only antenna. The coverage hole is caused by the near-far problem of interference caused by the pilot beacon, with the handset unable to receive the traffic pilot from the traffic antenna 202.

In a non-repeater deployment, i.e. one using a dedicated base station in a DAS, the power levels need to be set in a manner similar to that described above. The difference between the DAS and repeater situations is that repeated power levels typically vary over time when using a repeater, and may require re-adjustment if there is a change in propagation, donor antenna, etc. A dynamically changing algorithm for pilot power setting is therefore required. In the case of a base station, the power levels are generally held constant, although the dynamic power setting algorithm is useful during commissioning.

Signal applied to the DAC if analog otherwise, if digital, this is the digitized RF system. DACs and ADCs are placed in the system as needed to facilitate the use of the signal for transmission over the media, whether analog or digital.

In one embodiment, the pilot beacon signal is fed into the communication signal using a circuit 120 that receives a box that receives the GPS signal and feeds the position signal through a directional coupler. The specifications of the circuit 120 are shown in Table 1.

TABLE 1

| Characteristic | Performance Limit |
|---|---|
| Number of Bands per Beacon: | 1 |
| CDMA Band Class: | 0 (800 MHZ Band or 1 (900) Mhz |
| | Band) |
| Max # Simultaneous Channels/ | 8 (cell Band) 11 (PCS Band) |
| Beacons: (adjustable) | |
| Number of Unique PN Offsets/ | 1 |
| Beacon: | |
| Composite Tx power: (adjustable) | +19 dBm |
| Spurious Emissions Limits: | <45 dBc f. 75 to 1.98 MHz |
| | <−60 dBc f. 1.98 to 4.0 MHz |
| | <−65 dBc f. 4.0 to 16 MHz |
| | <−75 dBc f > 16 MHz |
| Carrier Frequency Accuracy: | 20 Hz (.2 ppm) Cell Band |
| | 40 Hz (.2 ppm) PCS Band |
| | When locked to GPS |
| Pilot Timing Jitter: | <10 nsec rms, <50 nsec peak |
| Rho: | >0.98 |
| Tau Adjustment Range: (adjustable) | 0 to 5.2 usec (0 to 4.2 CDMA |
| | chips) |
| Tau Adjustment Resolution: | ±20 nsec (one 40^{th} of a CDMA |
| | chip) |

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

It is recognized that any Physical Layer technology that provides for handsets to receive an accurately timed pilot signal from a base station may use the methods described. For example, newer systems such as LTE use the concept of location reference signals in the downlink from the cell site.

It is recognized that while CDMA2000 is described, older systems will also work, such as CDMA IS-95.

What is claimed:

1. A method of determining the location of a wireless handset, comprising:
positioning at least one repeating antenna in a location not capable of receiving a sufficiently strong signal from a carrier site to allow the handset to receive a communication signal;
positioning a radio frequency receiving device capable of receiving a signal from a carrier site;
repeating the signals from the radio frequency receiving device to the at least one repeating antenna and the signal from the at least one repeating antenna to the radio frequency receiving device;
providing a location signal; and
combining the communication signal and location signal; and
transmitting the combined communication and location signal from the at least one repeating antenna so that the handset can receive the signal and determine its position.

2. A method of claim 1 wherein the radio frequency receiving device is an exterior donor antenna.

3. A method of claim 1 wherein the radio frequency receiving device is a base station.

4. A method of claim 1 wherein the positioning of at least one antenna is positioning at least two antennas and the location signal includes an offset signal to distinguish the at least one repeating antenna.

5. A method of claim 1 wherein the positioning signal includes a timing offset to adjust the timing of the position signal to reflect delays.

6. A system for determining the location of a wireless device, the system comprising:
at least one repeating antenna;
a radio frequency receiving device capable of receiving a communication signal from a carrier site;
a positioning device for sending a positioning signal related to position of the positioning device; and
a coupler for feeding the positioning signal from the positioning device and the communication signal to the at least one repeating signal.

7. A system of claim 6 wherein the radio frequency receiving device is an exterior donor antenna.

8. A system of claim 6 wherein the radio frequency receiving device is a base station.

9. A system of claim 6 further comprising a timing offset to adjust the timing of the position signal to reflect delays in the system.

10. A system of claim 6 wherein the positioning device includes a GPS receiver and the at least one repeating antenna is at least two repeating antennas and the positioning signal is sent to each of the repeating antennas.

11. A system of claim 10 wherein the signal has an offset and a phase at each of the repeating antennas.

12. A method of determining the optimal level of pilot beacon signal comprising:
measuring the strength of the repeated signal;
obtaining information on acceptable pilot beacon/repeated signal strength ratios; and
setting the power of the pilot beacon and the repeated signal.

13. A position signal circuit comprising:
a field programmable gate array (FPGA);
an input adapted to received an external GPS signal for forwarding a signal to the FPGA;
a repeater antenna coupler adapted to communicate with at least one repeater antenna wherein the FPGA produces a timing signal for the at least one repeater antenna for assisting a wireless handset to determine the wireless handset's location.

14. A position signal circuit of claim 13 wherein the FPGA produces an even second tick.

15. A position signal circuit of claim 13 further comprising an external antenna coupler adapted to connect to an external donor antenna wherein the FPGA process the communication signal both in an uplink direction and a downlink direction.

16. A position signal circuit of claim 13 further comprising a Voltage Controlled (X) Crystal Oscillator and a phase locked loop to generate a stable time reference for the pilot beacon signal.

17. A position signal circuit of claim 13 further comprising a Temperature Compensated Voltage Controlled (X) Crystal Oscillator and a phase locked loop to generate a stable time reference for the pilot beacon signal.

18. A position signal circuit of claim 13 wherein the FPGA generates two bands of pilot beacon signals.
